(19) United States
(12) Patent Application Publication
(10) Pub. No.: US 2026/0339813 A1
(43) Pub. Date: Oct. 29, 2026

(54) REDUCING EFFECTIVE CLOCK FREQUENCY BY SKIPPING INDIVIDUAL CLOCK PULSES IN PROCESSOR-BASED DEVICES

(71) Applicant: Ampere Computing LLC, Santa Clara, CA (US)

(72) Inventors: Benjamin Crawford Chaffin, Portland, OR (US); Jonathan Christopher Perry, Portland, OR (US); Sanjay Bhikhubhai Patel, Durham, NC (US); Sean Philip Mirkes, Beaverton, OR (US); Bret Leslie Toll, Hillsboro, OR (US)

(21) Appl. No.: 19/188,777

(22) Filed: Apr. 24, 2025

(51) Int. Cl. G06F 11/34; G06F 1/08

(52) U.S. Cl. CPC G06F 11/3476; G06F 1/08; G06F 11/3409

(57) ABSTRACT

Aspects disclosed in the detailed description include reducing effective clock frequency by skipping individual clock pulses in processor-based devices. In an exemplary aspect, a processor-based device comprises a clock skip control circuit configured to transmit a root clock signal to secondary logic block circuits of a primary logic block circuit via a clock tree at a first clock duty cycle. The clock skip control circuit receives, from a subset of the secondary logic block circuits, a corresponding one or more idle indications. The clock skip control circuit determines whether every idle indication indicates that the corresponding secondary logic block circuit is idle. If so, the clock skip control circuit transmits the root clock signal to the secondary logic block circuits as a modified clock signal at a second clock duty cycle lower than the first clock duty cycle.

### TECHNICAL FIELD

The technology of the disclosure relates generally to reducing power consumption in processor-based devices by reducing effective clock frequency, and in particular to mechanisms for reducing effective clock frequency during short-duration idle periods.

### BACKGROUND

One performance and power management issue faced by conventional processor-based devices relates to memory access latency, which refers to the time required to retrieve requested data from a memory device such as Dynamic Random Access Memory (DRAM). Memory access latency may negatively impact the performance and power consumption of a processor-based device if the processor-based device runs out of useful work to perform while waiting for a memory access operation to complete. Consequently, the processor-based device may be forced to “stall,” or delay further instruction execution. As the processor clock frequencies at which modern processor-based devices operate continue to increase, more processor cycles and power are wasted during memory access operations, further exacerbating this issue. Modern processor-based devices attempt to mitigate the impact of memory access latency by performing speculative execution of instructions out-of-order while waiting for data to be returned from memory. In this manner, the processor-based device can speculatively perform productive work while waiting for data from memory.

However, speculative execution may also be subject to stalls, albeit stalls of shorter duration than stalls associated with memory access latency. For example, if a processor core requires access to a resource that is fully in use, the processor core will not be able to make progress until that resource is freed up, resulting in a stall. While such a stall may be relatively short (i.e., tens to hundreds of processor clock cycles), multiple such stalls collectively may result in significant delays and corresponding wasted power.

These shorter-duration stalls may be especially impactful because conventional power management mechanisms may not be effective in reducing the power consumption resulting from such stalls. For example, some such stalls may occur while waiting for a single instruction to complete, so software-based mitigation techniques may have no opportunity to address the stall. Modifying the clock frequency provided by a clock generator is similarly ineffective, because the time taken to change the clock frequency is much longer than the duration of such stalls. Conventional clock gating may be effective in some circumstances, but only when the corresponding structure or functional block is empty. For instance, if a scheduler circuit is empty, clock gating can be used to turn off the scheduler’s clock, thereby saving power. During a stall, though, the scheduler may not be empty, but rather must check during each processor clock cycle whether an entry has become ready.

Accordingly, it is desirable to provide a mechanism to reduce power consumption during these short-duration stalls.

### SUMMARY OF THE DISCLOSURE

Aspects disclosed in the detailed description include reducing effective clock frequency by skipping individual clock pulses in processor-based devices. Related methods and computer-readable media are also disclosed. In this regard, a processor-based device includes a cache memory device (e.g., a Level 2 (L2) cache, as a non-limiting example) and a primary logic block circuit that comprises a plurality of secondary logic block circuits communicatively coupled to a clock tree. The processor-based device further includes a clock generator circuit configured to generate a root clock signal, and a clock skip control circuit that is configured to generate a modified clock signal by changing the clock duty cycle of the root clock signal. In some aspects, the primary logic block circuit may comprise a processor core, while the secondary logic block circuits may comprise functional unit circuits of the processor core. Some aspects may provide that the primary logic block circuit comprises a mesh network circuit, while the secondary logic block circuits comprise routing block circuits of the mesh network circuit. According to some aspects, the primary logic block circuit may comprise an artificial intelligence (AI) matrix accelerator circuit, while the secondary logic block circuits may comprise processing element (PE) circuits of the AI matrix accelerator circuit.

In exemplary operation, the clock skip control circuit transmits the root clock signal generated by the clock generator circuit to the plurality of secondary logic block circuits of the processor-based device via the clock tree at a first clock duty cycle. The clock skip control circuit subsequently receives one or more idle indications from each secondary logic block circuits of a subset of the plurality of secondary logic block circuits (i.e., some or all of the secondary logic block circuits). The secondary logic block circuits that belong to the subset (and thus are monitored by the clock skip control circuit) may be specified by a secondary logic block circuit selection register of the clock skip control circuit, according to some aspects. The clock skip control circuit subsequently determines whether every idle indication of the one or more idle indications indicates that the corresponding secondary logic block circuit is idle. According to some aspects, the clock skip control circuit may perform this determination in response to receiving a cache miss indication from the cache memory device and/or in response to other criteria being met. In some aspects, this determination may comprise the clock skip control circuit determining that the corresponding secondary logic block circuit is idle for an idle delay time interval specified by an idle delay time register.

If the clock skip control circuit determines that the one or more idle indications indicate that every secondary logic block circuit of the subset is idle, the clock skip control circuit transmits the root clock signal to the plurality of secondary logic block circuits via the clock tree as a modified clock signal at a second clock duty cycle that is lower than the first clock duty cycle. This may be accomplished in some aspects by ramping the root clock signal from the first clock duty cycle down to the second clock duty cycle. Some aspects may further provide that the clock skip control circuit later resumes transmitting the root clock signal to the plurality of secondary logic block circuits via the clock tree at the first clock duty cycle (e.g., by ramping the root clock signal from the second clock duty cycle up to the first clock duty cycle, in some aspects). Some such aspects may provide that the clock skip control circuit resumes transmitting the root clock signal at the first clock duty cycle responsive to receiving an incoming data indication from the cache memory device.

According to some aspects, the processor-based device further comprises a performance monitoring counter that is configured to count occurrences of a specific hardware-related activity or event during operation of the processor-based device based on the current clock frequency of the processor-based device. To adjust the incrementing of the performance monitoring counter when the clock skip control circuit is modifying the root clock signal during periods in which the subset of the secondary logic block circuits is idle, the performance monitoring counter in such aspects is configured to increment a value of the performance monitoring counter by a value based on a current clock duty cycle (e.g., the first clock duty cycle and/or the second clock duty cycle) of the root clock signal. The value based on the current clock duty cycle may comprise, e.g., a value provided by the clock skip control circuit to the performance monitoring counter to indicate the value by which to increment the performance monitoring counter. Incrementing the value of the performance monitoring counter may comprise, e.g., incrementing the value by a multiple based on the current clock duty cycle.

In another exemplary aspect, a processor-based device is provided. The processor-based device comprises a primary logic block circuit that comprises a plurality of secondary logic block circuits communicatively coupled to a clock tree, and a clock generator circuit configured to generate a root clock signal. The processor-based device further comprises a clock skip control circuit that is configured to transmit the root clock signal to the plurality of secondary logic block circuits via the clock tree at a first clock duty cycle. The clock skip control circuit is further configured to receive, from a subset of the plurality of secondary logic block circuits, a corresponding one or more idle indications. The clock skip control circuit is also configured to determine whether every idle indication of the one or more idle indications indicates that a corresponding secondary logic block circuit is idle. The clock skip control circuit is further configured to, responsive to determining that every idle indication of the one or more idle indications indicates that the corresponding secondary logic block circuit is idle, transmit the root clock signal to the plurality of secondary logic block circuits via the clock tree as a modified clock signal at a second clock duty cycle that is lower than the first clock duty cycle.

In another exemplary aspect, a method for reducing effective clock frequency by skipping individual clock pulses in processor-based devices is provided. The method comprises transmitting, by a clock skip control circuit of a processor-based device, a root clock signal generated by a clock generator circuit of the processor-based device to a plurality of secondary logic block circuits of the processor-based device via a clock tree at a first clock duty cycle. The method further comprises receiving, by the clock skip control circuit from a subset of the plurality of secondary logic block circuits, a corresponding one or more idle indications. The method also comprises determining, by the clock skip control circuit, that every idle indication of the one or more idle indications indicates that a corresponding secondary logic block circuit is idle. The method further comprises, responsive to determining that every idle indication of the one or more idle indications indicates that the corresponding secondary logic block circuit is idle, transmitting, by the clock skip control circuit, the root clock signal to the plurality of secondary logic block circuits via the clock tree as a modified clock signal at a second clock duty cycle that is lower than the first clock duty cycle.

In another exemplary aspect, a non-transitory computer-readable medium stores thereon computer-executable instructions that, when executed by a processor device of a processor-based device, cause the processor device to transmit a root clock signal generated by a clock generator circuit of the processor-based device to a plurality of secondary logic block circuits of the processor-based device via a clock tree at a first clock duty cycle. The computer-executable instructions further cause the processor device to receive, from a subset of the plurality of secondary logic block circuits, a corresponding one or more idle indications. The computer-executable instructions also cause the processor device to determine whether every idle indication of the one or more idle indications indicates that a corresponding secondary logic block circuit is idle. The computer-executable instructions further cause the processor device to, responsive to determining that every idle indication of the one or more idle indications indicates that the corresponding secondary logic block circuit is idle, transmit the root clock signal to the plurality of secondary logic block circuits via the clock tree as a modified clock signal at a second clock duty cycle that is lower than the first clock duty cycle.

### BRIEF DESCRIPTION OF THE FIGURES

FIG. 1 is a block diagram of an exemplary processor-based device that comprises a clock skip control circuit configured to reduce effective clock frequency by skipping individual clock pulses, according to some aspects;

FIG. 2 is a diagram illustrating exemplary clock duty cycles at which the root clock signal of FIG. 1 may be transmitted by the clock skip control circuit of FIG. 1, according to some aspects;

FIGS. 3A-3C are diagrams illustrating exemplary aspects of the primary logic block circuit of FIG. 1, according to some aspects;

FIGS. 4A-4B provide a flowchart illustrating exemplary operations performed by the clock skip control circuit of FIG. 1 to reduce effective clock frequency by skipping individual clock pulses in a processor-based device, according to some aspects;

FIG. 5 provides a flowchart illustrating exemplary operations performed by the performance monitoring circuit of FIG. 1 for adjusting counter incrementing when the root clock signal FIG. 1 is transmitted at a modified clock duty cycle such as the second clock duty cycle of FIG. 2, according to some aspects; and

FIG. 6 is a block diagram of an exemplary processor-based system including a processor device comprising the clock skip control circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects. The terms “first,” “second,” and the like are used herein to distinguish between similarly named elements, and are not intended to indicate an ordinal relationship between or among such elements unless expressly described as such herein.

Aspects disclosed in the detailed description include reducing effective clock frequency by skipping individual clock pulses in processor-based devices. Related methods and computer-readable media are also disclosed. In this regard, a processor-based device includes a cache memory device (e.g., a Level 2 (L2) cache, as a non-limiting example) and a primary logic block circuit that comprises a plurality of secondary logic block circuits communicatively coupled to a clock tree. The processor-based device further includes a clock generator circuit configured to generate a root clock signal, and a clock skip control circuit that is configured to generate a modified clock signal by changing the clock duty cycle of the root clock signal. In some aspects, the primary logic block circuit may comprise a processor core, while the secondary logic block circuits may comprise functional unit circuits of the processor core. Some aspects may provide that the primary logic block circuit comprises a mesh network circuit, while the secondary logic block circuits comprise routing block circuits of the mesh network circuit. According to some aspects, the primary logic block circuit may comprise an artificial intelligence (AI) matrix accelerator circuit, while the secondary logic block circuits may comprise processing element (PE) circuits of the AI matrix accelerator circuit.

In exemplary operation, the clock skip control circuit transmits the root clock signal generated by the clock generator circuit to the plurality of secondary logic block circuits of the processor-based device via the clock tree at a first clock duty cycle. The clock skip control circuit subsequently receives one or more idle indications from each secondary logic block circuits of a subset of the plurality of secondary logic block circuits (i.e., some or all of the secondary logic block circuits). The secondary logic block circuits that belong to the subset (and thus are monitored by the clock skip control circuit) may be specified by a secondary logic block circuit selection register of the clock skip control circuit, according to some aspects. The clock skip control circuit subsequently determines whether every idle indication of the one or more idle indications indicates that the corresponding secondary logic block circuit is idle. According to some aspects, the clock skip control circuit may perform this determination in response to receiving a cache miss indication from the cache memory device and/or in response to other criteria being met. In some aspects, this determination may comprise the clock skip control circuit determining that the corresponding secondary logic block circuit is idle for an idle delay time interval specified by an idle delay time register.

If the clock skip control circuit determines that the one or more idle indications indicate that every secondary logic block circuit of the subset is idle, the clock skip control circuit transmits the root clock signal to the plurality of secondary logic block circuits via the clock tree as a modified clock signal at a second clock duty cycle that is lower than the first clock duty cycle. This may be accomplished in some aspects by ramping the root clock signal from the first clock duty cycle down to the second clock duty cycle. Some aspects may further provide that the clock skip control circuit later resumes transmitting the root clock signal to the plurality of secondary logic block circuits via the clock tree at the first clock duty cycle (e.g., by ramping the root clock signal from the second clock duty cycle up to the first clock duty cycle, in some aspects). Some such aspects may provide that the clock skip control circuit resumes transmitting the root clock signal at the first clock duty cycle responsive to receiving an incoming data indication from the cache memory device.

According to some aspects, the processor-based device further comprises a performance monitoring counter that is configured to count occurrences of a specific hardware-related activity or event during operation of the processor-based device based on the current clock frequency of the processor-based device. To adjust the incrementing of the performance monitoring counter when the clock skip control circuit is modifying the root clock signal during periods in which the subset of the secondary logic block circuits is idle, the performance monitoring counter in such aspects is configured to increment a value of the performance monitoring counter by a value based on a current clock duty cycle (e.g., the first clock duty cycle and/or the second clock duty cycle) of the root clock signal. The value based on the current clock duty cycle may comprise, e.g., a value provided by the clock skip control circuit to the performance monitoring counter to indicate the value by which to increment the performance monitoring counter. Incrementing the value of the performance monitoring counter may comprise, e.g., incrementing the value by a multiple based on the current clock duty cycle.

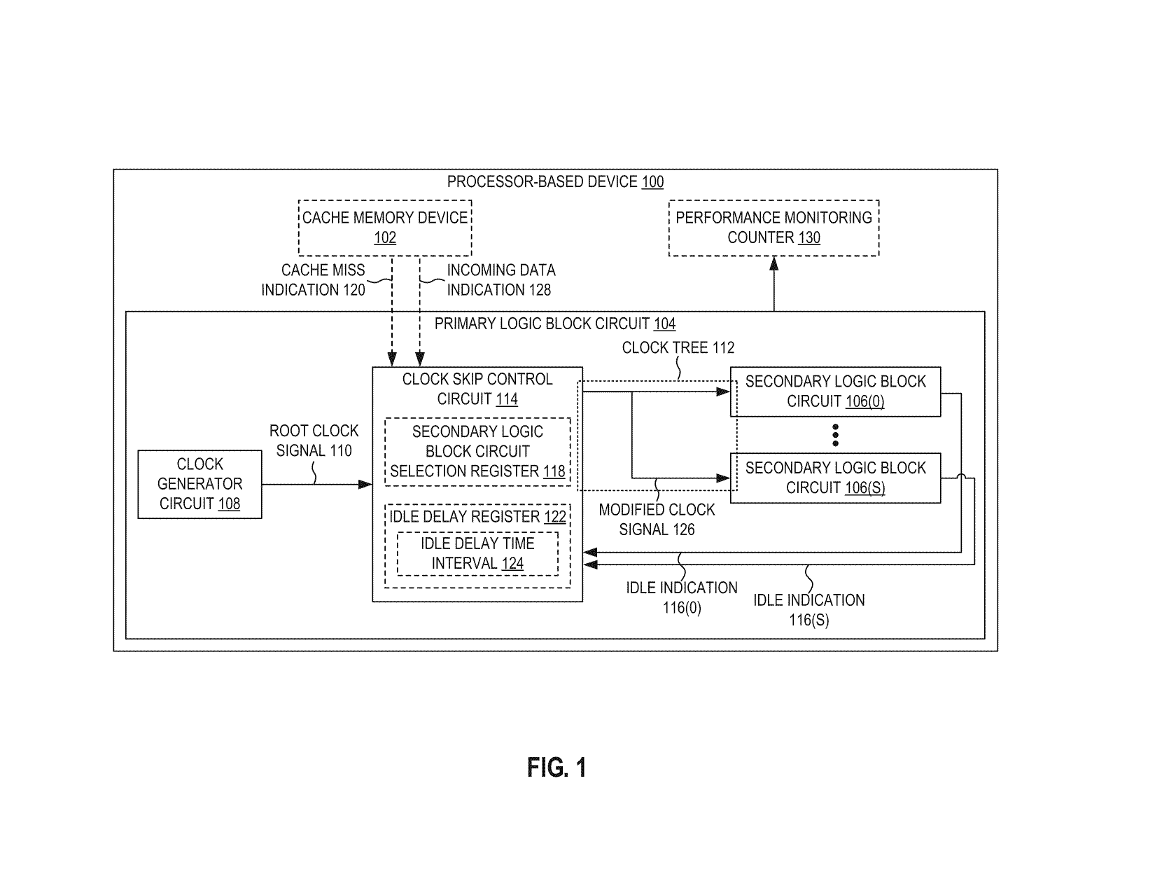

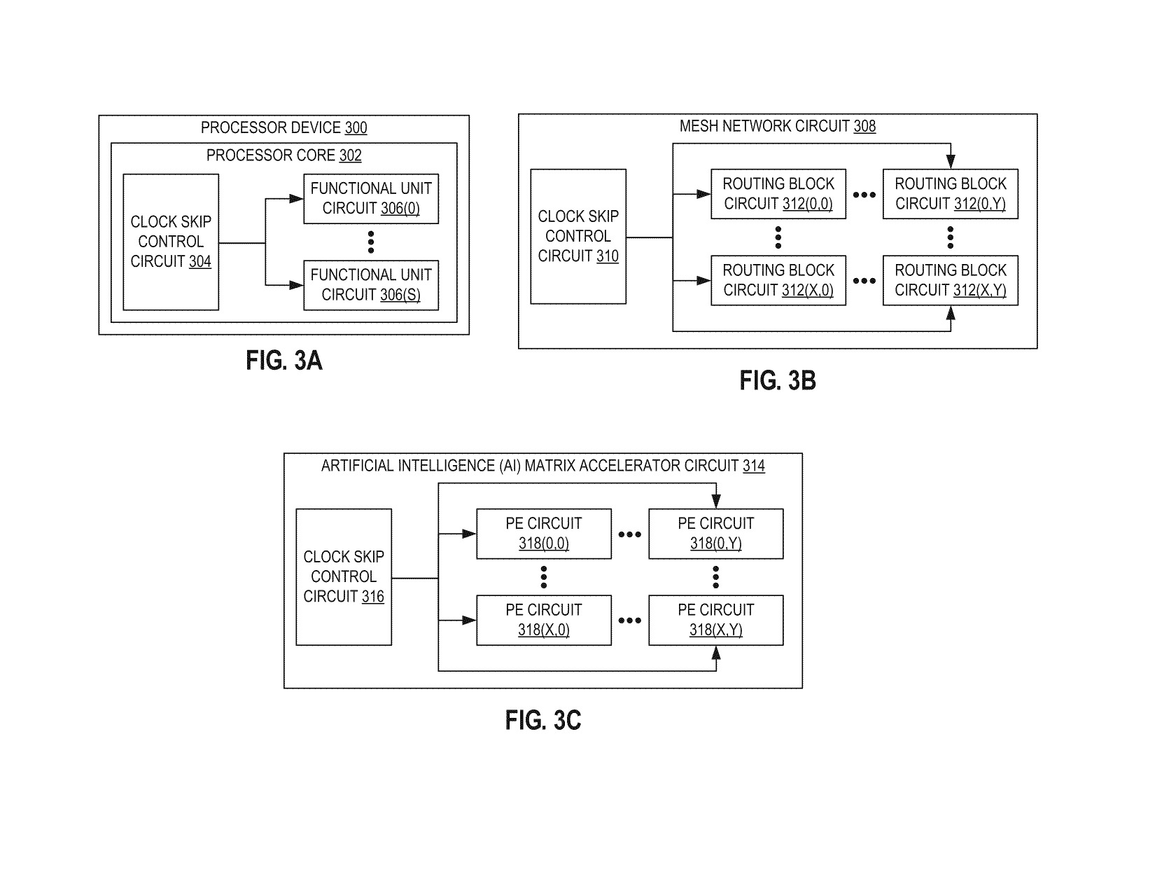

In this regard, FIG. 1 is a block diagram of a processor-based device 100 that is configured to reduce effective clock frequency by skipping individual clock pulses. The processor-based device 100 in the example of FIG. 1 includes a cache memory device 102 that may comprise, e.g., a Level 2 (L2) cache. The processor-based device 100 further comprises a primary logic block circuit 104 that includes a plurality of secondary logic block circuits 106(0)-106(S). As discussed in greater detail below with respect to FIG. 3, the primary logic block circuit 104 in some aspects may comprise a processor core, while the secondary logic block circuits 106(0)-106(S) may comprise functional unit circuits of the processor core. Some aspects may provide that the primary logic block circuit 104 comprises a mesh network circuit, while the secondary logic block circuits 106(0)-106(S) comprise routing block circuits of the mesh network circuit. According to some aspects, the primary logic block circuit 104 may comprise an AI matrix accelerator circuit, while the secondary logic block circuits 106(0)-106(S) may comprise PE circuits of the AI matrix accelerator circuit.

In the example of FIG. 1, the primary logic block circuit 104 includes a clock generator circuit 108 configured to generate a root clock signal 110 that is distributed to each of the secondary logic block circuits 106(0)-106(S) via a clock tree 112. The root clock signal 110 comprises a clock signal that, in conventional operation, is provided to all of the secondary logic block circuits 106(0)-106(S), while the clock tree 112 comprises circuitry via which the root clock signal 110 is transmitted. While not shown in FIG. 1, it is to be understood that one or more of the secondary logic block circuits 106(0)-106(S) may be configured to perform internal clock gating to control the provision of clock signals such as the root clock signal 110 to internal elements. The clock generator circuit 108 may comprise, e.g., a phased-lock loop (PLL) circuit, as a non-limiting example.

The processor-based device 100 of FIG. 1 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. It is to be understood that some aspects of the processor-based device 100 may include elements in addition to those illustrated in FIG. 1, and/or may include more or fewer of the elements illustrated in FIG. 1. For example, the processor-based device 100 may further include caches, controllers, communications buses, and/or persistent storage devices, which are omitted from FIG. 1 for the sake of clarity. Additionally, it is to be further understood that some elements illustrated as separate in FIG. 1 may be integrated into a same structure, and/or that some elements illustrated as a single structure in FIG. 1 may be implemented as separate structures. For example, the clock generator circuit 108 of FIG. 1 may be implemented as a structure separate from the primary logic block circuit 104 according to some aspects.

As noted above, processor-based devices such as the processor-based device 100 of FIG. 1 may perform speculative execution of instructions to minimize the effects of stalls associated with memory access latency. However, such speculative execution itself may be subject to stalls of shorter duration (i.e., tens to hundreds of processor clock cycles) that collectively result in significant delays and corresponding wasted power. Conventional power management mechanisms, such as software-based mitigation techniques, clock frequency modification, and clock gating (such as that provided by individual secondary logic block circuits 106(0)-106(S) in some aspects) may not be effective in reducing the power consumption resulting from such shorter-duration stalls.

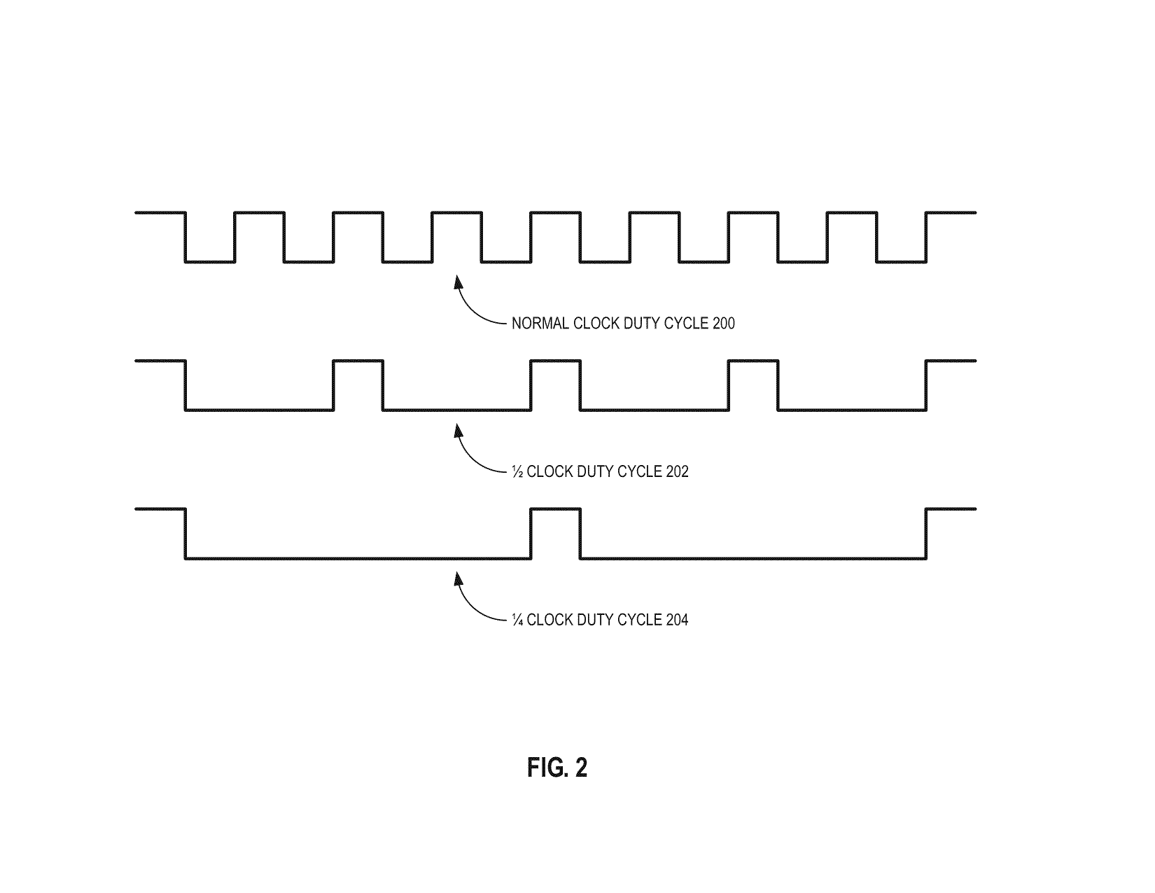

In this regard, the primary logic block circuit 104 provides a clock skip control circuit 114 that is configured to reduce effective clock frequency by skipping individual clock pulses. In exemplary operation, the clock skip control circuit 114 receives the root clock signal 110 from the clock generator circuit 108, and transmits the root clock signal 110 generated by the clock generator circuit 108 to the secondary logic block circuits 106(0)-106(S) via the clock tree 112 at a first clock duty cycle. The first clock duty cycle may comprise, e.g., a conventional clock duty cycle in which the root clock signal 110 is in a high state during 50% of the clock pulse width and is in a low state during 50% of the pulse width, such that the length of each high state and each low state is the same. An example of such a clock duty cycle is illustrated and discussed in greater detail below with respect to FIG. 2.

The clock skip control circuit 114 subsequently receives, from a subset of the plurality of secondary logic block circuits 106(0)-106(S), a corresponding one or more idle indications 116(0)-116(S). The subset may comprise all of the secondary logic block circuits 106(0)-106(S), or may comprise fewer than all of the secondary logic block circuits 106(0)-106(S). Some aspects may provide that the clock skip control circuit 114 comprises a secondary logic block circuit selection register 118 that stores a bitmap indicating which of the secondary logic block circuits 106(0)-106(S) are part of the subset. Thus, by modifying the contents of the secondary logic block circuit selection register 118, the secondary logic block circuits 106(0)-106(S) that make up the subset being monitored by the clock skip control circuit 114 can be changed. For purposes of illustration, it is assumed in describing FIG. 1 that the subset includes all of the secondary logic block circuits 106(0)-106(S).

Each of the idle indications 116(0)-116(S) comprises a signal generated by the corresponding secondary logic block circuit 106(0)-106(S) to indicate whether or not the secondary logic block circuit 106(0)-106(S) is currently able to perform work. For example, in aspects in which the primary logic block circuit 104 comprises a processor core and the secondary logic block circuit 106(0) comprises an execution unit circuit, the idle indication 116(0) corresponding to the secondary logic block circuit 106(0) may be set to indicate an idle state when the secondary logic block circuit 106(0) is currently not executing any instructions and there are no instructions ready to issue or about to become ready to issue. The criteria and corresponding logic for determining whether each of the secondary logic block circuits 106(0)-106(S) is idle may be specific to the type and implementation of the secondary logic block circuit 106(0)-106(S).

The clock skip control circuit 114 subsequently determines whether every one of the idle indications 116(0)-116(S) indicates that the corresponding secondary logic block circuit 106(0)-106(S) is idle. In some aspects, the clock skip control circuit 114 may perform this determination in response to receiving a cache miss indication 120 from the cache memory device 102 (e.g., in response to an L2 cache miss), and/or in response to other configurable criteria being met. According to some aspects, the clock skip control circuit 114 includes an idle delay register 122 that stores an idle delay time interval 124 indicating, e.g., a count of idle processor cycles that must elapse before clock skipping is initiated In such aspects, determining whether all of the subset of the secondary logic block circuits 106(0)-106(S) is idle may comprise the clock skip control circuit 114 determining that every idle indication of the one or more idle indications 116(0)-116(S) indicates that the corresponding secondary logic block circuit 106(0)-106(S) is idle for the idle delay time interval 124. In this manner, the idle delay register 122 and the idle delay time interval 124 can ensure that a secondary logic block circuit 106(0)-106(S) that goes idle for a very short time interval (e.g., one (1) or two (2) processor clock cycles) does not trigger clock skipping and incur the associated performance costs.

Upon determining that every idle indication of the one or more idle indications 116(0)-116(S) indicates that the corresponding secondary logic block circuit 106(0)-106(S) is idle, the clock skip control circuit 114 transmits the root clock signal 110 to the plurality of secondary logic block circuits 106(0)-106(S) via the clock tree 112 as a modified clock signal 126 at a second clock duty cycle that is lower than the first clock duty cycle. For instance, the second clock duty cycle may comprise a ½ clock duty cycle or a ¼ clock duty cycle, as non-limiting examples. Examples of such clock duty cycles are discussed below in greater detail with respect to FIG. 3. Note that, in some aspects, the logic embodied by the clock skip control circuit 114 modifies the root clock signal 110 but can operate using the modified clock signal 126.Some aspects may provide that the operations for transmitting the root clock signal 110 at the second clock duty cycle may comprise the clock skip control circuit 114 ramping the root clock signal 110 from the first clock duty cycle down to the second clock duty cycle. As used herein, “ramping” the root clock signal 110 refers to transmitting the root clock signal 110 as the modified clock signal 126 using one or more intermediate clock duty cycles between a starting clock duty cycle and a target clock duty cycle. Thus, for instance, instead of immediately switching from a normal clock duty cycle to a ¼ clock duty cycle, the clock skip control circuit 114 may first switch from the normal clock duty cycle to a ½ clock duty cycle, and subsequently switch from a ½ clock duty cycle to a ¼ clock duty cycle. In this manner, current surges and voltage droop that may be triggered by rapid transitions between clock duty cycles may be minimized.

The clock skip control circuit 114 according to some aspects may resume transmitting the root clock signal 110 to the plurality of secondary logic block circuits 106(0)-106(S) via the clock tree 112 at the first clock duty cycle. Some such aspects may provide that the clock skip control circuit 114 may resume transmitting the root clock signal 110 at the first clock duty cycle in response to receiving an incoming data indication 128 from the cache memory device 102 that indicates that data being retrieved from a memory device (not shown) is arriving at the cache memory device 102. In some aspects, the operations for resuming transmitting the root clock signal 110 at the first clock duty cycle may comprise the clock skip control circuit 114 ramping the root clock signal 110 from the second clock duty cycle up to the first clock duty cycle.

Some aspects may provide that the processor-based device 100 further comprises a performance monitoring counter 130 that is configured to count occurrences of a specific hardware-related activity or event during operation of the processor-based device 100. Because the performance monitoring counter 130 may be configured to count such occurrences based on the current clock frequency of the processor-based device, it may be necessary in such aspects to adjust the incrementing of the performance monitoring counter 130 when the clock skip control circuit 114 is modifying the root clock signal 110 during periods in which the subset of the secondary logic block circuits 106(0)-106(S) is idle. Accordingly, in some aspects, the performance monitoring counter 130 is configured to detect an occurrence of a monitored event. In response to detecting the occurrence of the monitored event, the performance monitoring counter 130 increments a value of the performance monitoring counter 130 by a value based on a current clock duty cycle (e.g., the first clock duty cycle and/or the second clock duty cycle) of the root clock signal 110. In some aspects, the value based on the current clock duty cycle may comprise, e.g., a value provided by the clock skip control circuit 114 to the performance monitoring counter 130 to indicate the value by which to increment the performance monitoring counter 130. Incrementing the value of the performance monitoring counter 130 may comprise, e.g., incrementing the value by a multiple based on the current clock duty cycle. Thus, for example, if the current clock duty cycle is a ½ clock duty cycle, the value of the performance monitoring counter 130 may be incremented by a multiple of two (2) for each monitored event that is detected.

FIG. 2 is a diagram illustrating exemplary clock duty cycles to which the root clock signal 110 of FIG. 1 may be modified and transmitted by the clock skip control circuit 114 as the modified clock signal 126 of FIG. 1, according to some aspects. In FIG. 2, a normal clock duty cycle 200, such as that of the root clock signal 110 of the clock generator circuit 108, is shown. As seen in FIG. 2, the normal clock duty cycle 200 illustrated therein is one in which the clock signal is in a high state during 50% of the pulse width and is in a low state during 50% of the pulse width, such that the length of each high state and each low state is the same. If the clock skip control circuit 114 transmits the root clock signal 110 as the modified clock signal 126 using a ½ clock duty cycle 202 as shown in FIG. 2, alternating high states of the clock signal are skipped and the low states are extended. This results in half the number of high states during a given period compared to the normal clock duty cycle 200, effectively halving the clock frequency. Similarly, if the clock skip control circuit 114 transmits the root clock signal 110 as the modified clock signal 126 using a ¼ clock duty cycle 204 seen in FIG. 2, three (3) of every four (4) high states are skipped and the low states are further extended, resulting in one-quarter the number of high states during a given period. This has the effect of reducing the effective clock frequency to 25% of the unmodified root clock signal 110.

As noted above, in some aspects, the clock skip control circuit 114 may transmit the root clock signal 110 as the modified clock signal 126 by ramping down from a first clock duty cycle to a second clock duty cycle and/or by ramping up from the second clock duty cycle to the first clock duty cycle. This may minimize current surges and voltage droop that may be triggered by rapid transitions between, for example, the normal clock duty cycle 200 and the ¼ clock duty cycle 204 of FIG. 2. In such aspects, when the clock skip control circuit 114 receives the cache miss indication 120 of FIG. 1 and determines, based on the idle indications 116(0)-116(S), that all of the monitored subset of secondary logic block circuits 106(0)-106(S) are idle, the clock skip control circuit 114 may first change the clock duty cycle of the root clock signal 110 from the normal clock duty cycle 200 of FIG. 2 to the ½ clock duty cycle 202 of FIG. 2. Subsequently, the clock skip control circuit 114 may further change the clock duty cycle of the root clock signal 110 from the ½ clock duty cycle 202 to the ¼ clock duty cycle 204 of FIG. 2. Likewise, in some aspects, when the clock skip control circuit 114 receives the incoming data indication 128 from the cache memory device 102, the clock skip control circuit 114 may first change the clock duty cycle of the root clock signal 110 from the ¼ clock duty cycle 204 of FIG. 2 to the ½ clock duty cycle 202, and then further change the clock duty cycle of the root clock signal 110 from the ½ clock duty cycle 202 of FIG. 2 to the normal clock duty cycle 200 of FIG. 2.

In exemplary aspects disclosed herein, the primary logic block circuit 104 of FIG. 1 may be implemented as different elements of the processor-based device 100 of FIG. 1. In this regard, FIGS. 3A-3C illustrate some exemplary implementations of the primary logic block circuit 104. In FIG. 3A, a processor device 300 that includes a processor core 302 corresponding to the primary logic block circuit 104 of FIG. 1 in some aspects is shown. The processor core 302 in such aspects may be one of a plurality of processor cores, and in this example comprises a clock skip control circuit 304 that corresponds in functionality to the clock skip control circuit 114 of FIG. 1. The processor core 302 also comprises a plurality of functional unit circuits 306(0)-306(S) that correspond to the secondary logic block circuits 106(0)-106(S) of FIG. 1. Each of the functional unit circuits 306(0)-306(S) in the example of FIG. 3A embodies a specific logic or functionality of the processor core 302, and thus may comprise, e.g., a fetch unit circuit, a rename unit circuit, an execution unit circuit, an arithmetic/logic unit (ALU) circuit, a floating-point unit (FPU) circuit, a load/store unit (LSU) circuit, and/or the like, as non-limiting examples.

FIG. 3B shows a mesh network circuit 308 that corresponds to the primary logic block circuit 104 of FIG. 1 according to some aspects. The mesh network circuit 308 of FIG. 3B comprises a clock skip control circuit 310 that corresponds in functionality to the clock skip control circuit 114 of FIG. 1, and further comprises a plurality of routing block circuits 312(0,0)-312(X,Y) that correspond to the secondary logic block circuits 106(0)-106(S) of FIG. 1. The routing block circuits 312(0,0)-312(X,Y) of the mesh network circuit 308 are configured to relay inter-network communication packets (not shown) between neighboring routing block circuits 312(0,0)-312(X,Y).

Finally, FIG. 3C illustrates an AI matrix accelerator circuit 314 that corresponds to the primary logic block circuit 104 of FIG. 1 in some aspects, and that comprises a clock skip control circuit 316 corresponding in functionality to the clock skip control circuit 114 of FIG. 1. The AI matrix accelerator circuit 314 includes a plurality of PE circuits 318(0,0)-318(X,Y) that each comprise a fundamental computational unit for performing operations necessary for AI workloads, including matrix multiplication and addition operations. The PE circuits 318(0,0)-318(X,Y) in the example of FIG. 3C correspond to the secondary logic block circuits 106(0)-106(S) of FIG. 1.

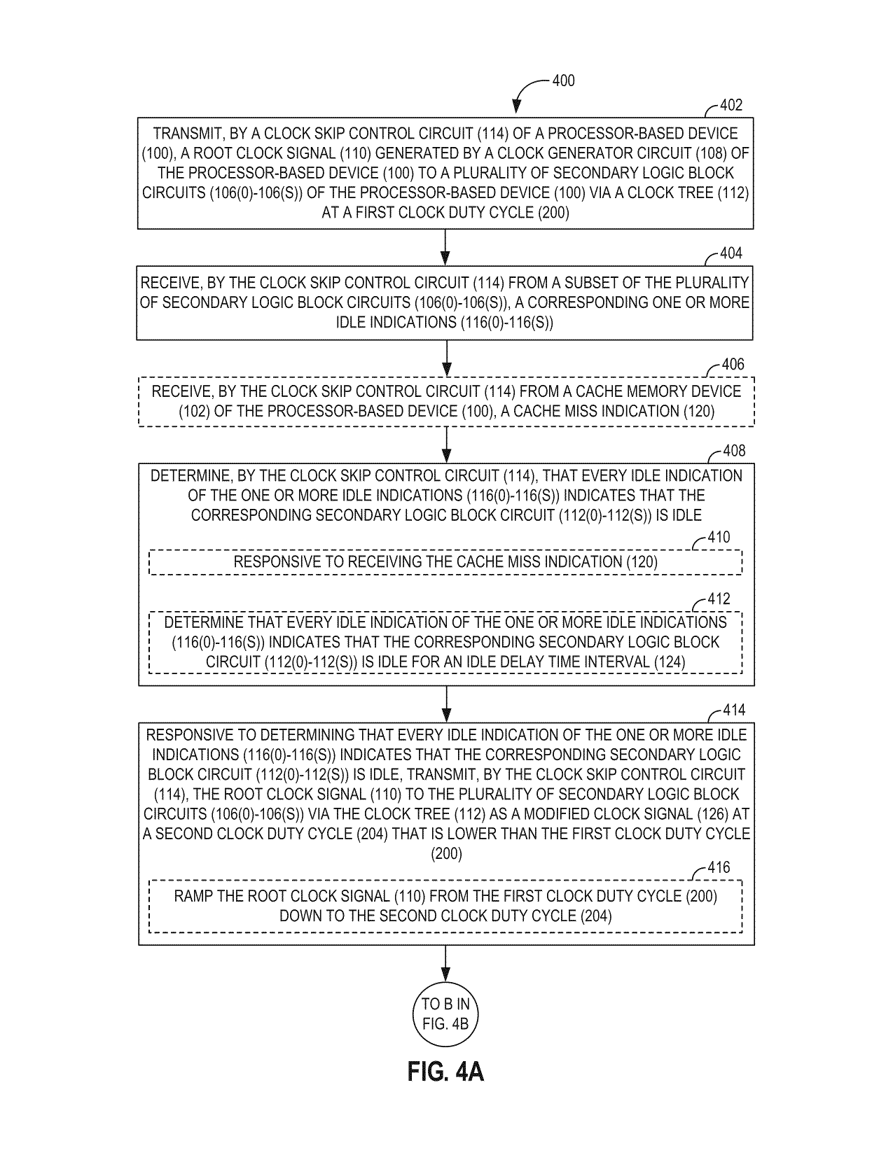

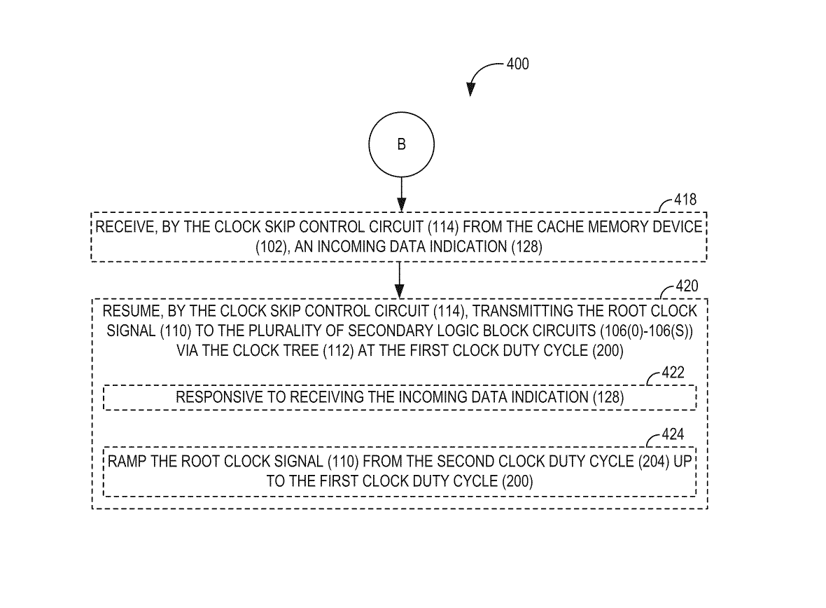

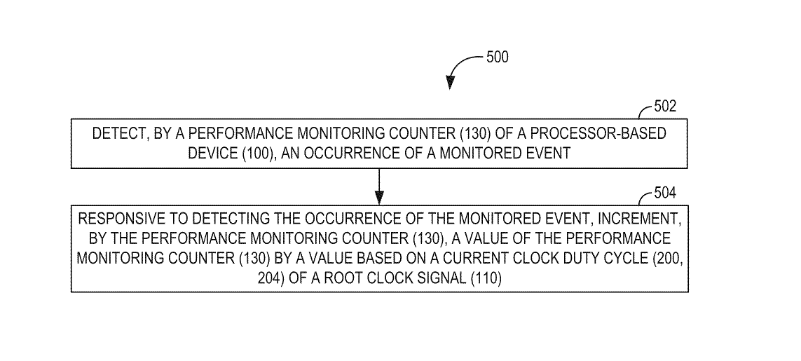

To illustrate exemplary operations performed by the clock skip control circuit 114 of FIG. 1 to reduce effective clock frequency by skipping individual clock pulses according to some aspects, FIGS. 4A-4B provide a flowchart showing exemplary operations 400. Elements of FIGS. 1-2 are referenced in describing FIGS. 4A-4B for the sake of clarity. It is to be understood that some of the exemplary operations 400 shown in FIGS. 4A-4B may be performed in an order other than that illustrated herein in some aspects, and/or may be omitted in some aspects.

The exemplary operations 400 begin in FIG. 4A with a clock skip control circuit (e.g., the clock skip control circuit 114 of FIG. 1) of a processor-based device (such as the processor-based device 100 of FIG. 1) transmitting a root clock signal (e.g., the root clock signal 110 of FIG. 1) generated by a clock generator circuit (such as the clock generator circuit 108 of FIG. 1) of the processor-based device 100 to a plurality of secondary logic block circuits (e.g., the secondary logic block circuits 106(0)-106(S) of FIG. 1) of the processor-based device 100 via a clock tree (such as the clock tree 112 of FIG. 1) at a first clock duty cycle (e.g., the clock duty cycle 200 of FIG. 2) (block 402). The clock skip control circuit 114 receives, from a subset of the plurality of secondary logic block circuits 106(0)-106(S), a corresponding one or more idle indications (such as the idle indications 116(0)-116(S) of FIG. 1) (block 404). According to some aspects, the clock skip control circuit 114 may also receive, from a cache memory device (e.g., the cache memory device 102 of FIG. 1) of the processor-based device 100, a cache miss indication (such as the cache miss indication 120 of FIG. 1) (block 406).

The clock skip control circuit 114 subsequently determines whether every idle indication of the one or more idle indications 116(0)-116(S) indicates that the corresponding secondary logic block circuit 106(0)-106(S) is idle (block 408). Some aspects may provide that the operations of block 408 for determining whether every idle indication of the one or more idle indications 116(0)-116(S) indicates that the corresponding secondary logic block circuit 106(0)-106(S) is idle may be performed responsive to receiving the cache miss indication 120 (block 410). In some aspects, the operations of block 408 for determining whether every idle indication of the one or more idle indications 116(0)-116(S) indicates that the corresponding secondary logic block circuit 106(0)-106(S) is idle may comprise the clock skip control circuit 114 determining that every idle indication of the one or more idle indications 116(0)-116(S) indicates that the corresponding secondary logic block circuit 106(0)-106(S) is idle for an idle delay time interval (e.g., the idle delay time interval 124 of FIG. 1) (block 412). If the clock skip control circuit 114 determines that every idle indication of the one or more idle indications 116(0)-116(S) indicates that the corresponding secondary logic block circuit 106(0)-106(S) is idle, the clock skip control circuit 114 transmits the root clock signal 110 to the plurality of secondary logic block circuits 106(0)-106(S) via the clock tree 112 as a modified clock signal (e.g., the modified clock signal 126 of FIG. 1) at a second clock duty cycle (such as the clock duty cycle 204 of FIG. 2) that is lower than the first clock duty cycle 200 (block 414). Some aspects may provide that the operations of block 414 for transmitting the root clock signal 110 at the second clock duty cycle 204 may comprise the clock skip control circuit 114 ramping the root clock signal 110 from the first clock duty cycle 200 down to the second clock duty cycle 204 (block 416). The exemplary operations 400 in some aspects may continue at block 418 of FIG. 4B.

Referring now to FIG. 4B, the clock skip control circuit 114 according to some aspects may subsequently receive, from the cache memory device 102, an incoming data indication (e.g., the incoming data indication 128 of FIG. 1) (block 418). The clock skip control circuit 114 resumes transmitting the root clock signal 110 to the plurality of secondary logic block circuits 106(0)-106(S) via the clock tree 112 at the first clock duty cycle 200 (block 420). Some aspects may provide that the operations of block 420 for resuming transmitting the root clock signal 110 at the first clock duty cycle 200 are performed in response to receiving the incoming data indication 128 (block 422). In some aspects, the operations of block 420 for resuming transmitting the root clock signal 110 at the first clock duty cycle 200 may comprise the clock skip control circuit 114 ramping the root clock signal 110 from the second clock duty cycle 204 up to the first clock duty cycle 200 (block 424).

FIG. 5 provides a flowchart showing exemplary operations 500 performed by the performance monitoring counter 130 of FIG. 1 to adjust counter incrementing when the root clock signal 110 is transmitted at a modified clock duty cycle according to some aspects. For the sake of clarity, elements of FIGS. 1-2 are referenced in describing FIG. 5. In FIG. 5, the exemplary operations 500 begin with a performance monitoring counter (e.g., the performance monitoring counter 130 of FIG. 1) of a processor-based device (such as the processor-based device 100 of FIG. 1) detecting an occurrence of a monitored event (block 502). In response to detecting the occurrence of the monitored event, the performance monitoring counter 130 increments a value of the performance monitoring counter 130 by a value based on a current clock duty cycle (e.g., the first clock duty cycle 200 and/or the second clock duty cycle 204 of FIG. 2) of a root clock signal (e.g., the root clock signal 110 of FIG. 1) (block 504).

The exemplary clock skip control circuit according to aspects disclosed herein and discussed with reference to FIGS. 1, 2, 3A-3C, 4A-4B, and 5 may be provided in or integrated into any processor-based device. Examples, without limitation, include a server, a computer, a portable computer, a desktop computer, a mobile computing device, a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a wearable computing device (e.g., a smart watch, a health or fitness tracker, eyewear, etc.), a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

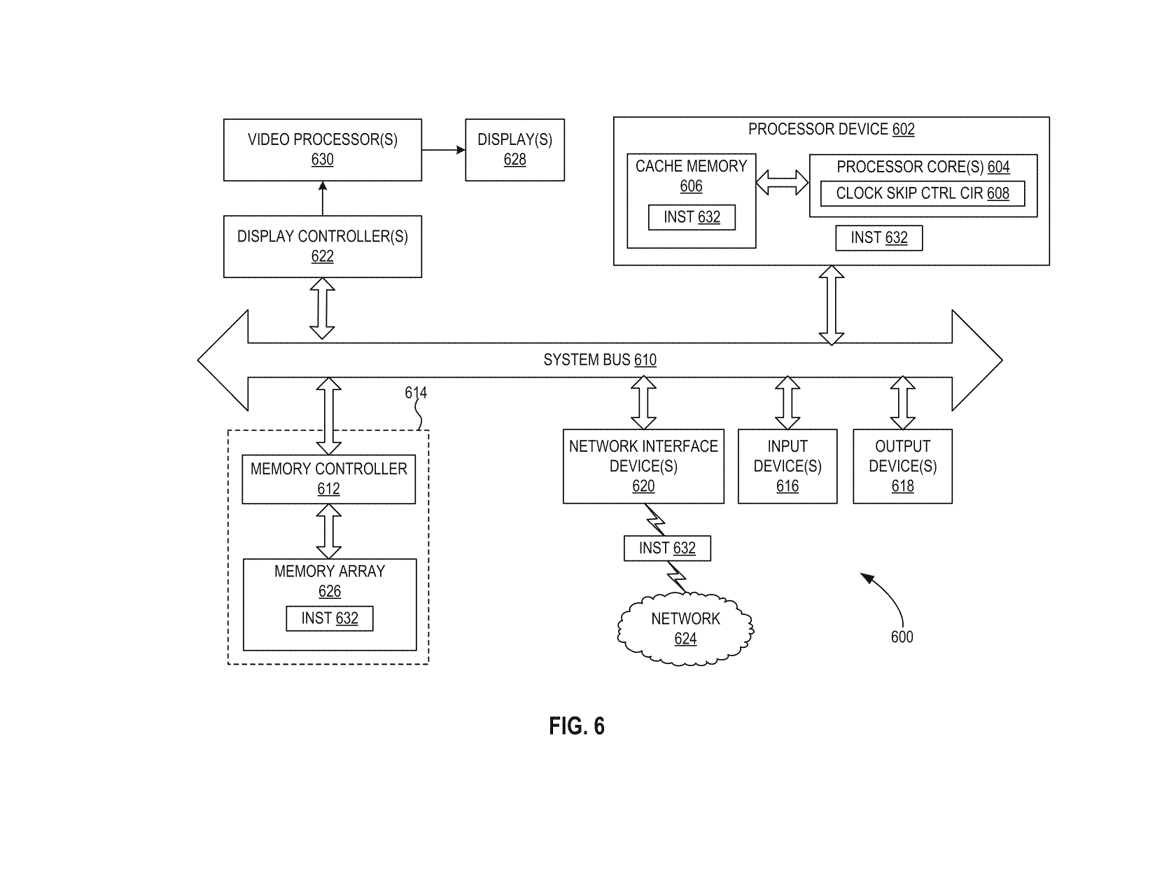

In this regard, FIG. 6 illustrates an example of a processor-based device 600 corresponding in functionality to the processor-based device 100 of FIG. 1. In this example, the processor-based device 600 includes a processor device 602, which comprises one or more processor cores 604 coupled to a cache memory 606. The one or more processor cores 604 include a clock skip control circuit (captioned as “CLOCK SKIP CTRL CIR” in FIG. 6) 608 that corresponds in functionality to the clock skip control circuit 114 of FIG. 1. The processor device 602 is also coupled to a system bus 610 and can intercouple devices included in the processor-based device 600. As is well known, the processor device 602 communicates with these other devices by exchanging address, control, and data information over the system bus 610. For example, the processor device 602 can communicate bus transaction requests to a memory controller 612. Although not illustrated in FIG. 6, multiple system buses 610 could be provided, wherein each system bus 610 constitutes a different fabric.

Other devices may be connected to the system bus 610. As illustrated in FIG. 6, these devices can include a memory system 614, one or more input devices 616, one or more output devices 618, one or more network interface devices 620, and one or more display controllers 622, as examples. The input device(s) 616 can include any type of input device, including, but not limited to, input keys, switches, voice processors, etc. The output device(s) 618 can include any type of output device, including, but not limited to, audio, video, other visual indicators, etc. The network interface device(s) 620 can be any devices configured to allow exchange of data to and from a network 624. The network 624 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 620 can be configured to support any type of communications protocol desired. The memory system 614 can include the memory controller 612 coupled to one or more memory arrays 626.

The processor device 602 may also be configured to access the display controller(s) 622 over the system bus 610 to control information sent to one or more displays 628. The display controller(s) 622 sends information to the display(s) 628 to be displayed via one or more video processors 630, which process the information to be displayed into a format suitable for the display(s) 628. The display(s) 628 can include any type of display, including, but not limited to, a cathode ray tube (CRT), a liquid crystal display (LCD), a plasma display, a light emitting diode (LED) display, etc.

The processor-based device 600 in FIG. 6 may include a set of instructions (captioned as “INST” in FIG. 6) 632 that may be executed by the processor device 602 for any application desired according to the instructions. The instructions 632 may be stored in the memory system 614, the processor device 602, and/or the cache memory 606, each of which may comprise an example of a non-transitory computer-readable medium. The instructions 632 may also reside, completely or at least partially, within the memory system 614 and/or within the processor device 602 during their execution. The instructions 632 may further be transmitted or received over the network 624, such that the network 624 may comprise an example of a computer-readable medium.

While the computer-readable medium is described in an exemplary embodiment herein to be a single medium, the term “computer-readable medium” should be taken to include a single medium or multiple media (e.g., a centralized or distributed database, and/or associated caches and servers) that store the set of instructions 632. The term “computer-readable medium” shall also be taken to include any medium that is capable of storing, encoding, or carrying a set of instructions for execution by a processing device and that cause the processing device to perform any one or more of the methodologies of the embodiments disclosed herein. The term “computer-readable medium” shall accordingly be taken to include, but not be limited to, solid-state memories, optical medium, and magnetic medium.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The controlling devices and controlled devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A processor-based device, comprising:
a primary logic block circuit comprising:
a plurality of secondary logic block circuits communicatively coupled to a clock tree;
a clock generator circuit configured to generate a root clock signal; and
a clock skip control circuit configured to:
transmit the root clock signal to the plurality of secondary logic block circuits via the clock tree at a first clock duty cycle;
receive, from a subset of the plurality of secondary logic block circuits, a corresponding one or more idle indications;
determine whether every idle indication of the one or more idle indications indicates that a corresponding secondary logic block circuit is idle; and
responsive to determining that every idle indication of the one or more idle indications indicates that the corresponding secondary logic block circuit is idle, transmit the root clock signal to the plurality of secondary logic block circuits via the clock tree as a modified clock signal at a second clock duty cycle that is lower than the first clock duty cycle.

2. The processor-based device of claim 1, wherein:
the processor-based device further comprises a cache memory device;
the clock skip control circuit is further configured to receive, from the cache memory device, a cache miss indication; and
the clock skip control circuit is configured to determine whether every idle indication of the one or more idle indications indicates that a corresponding secondary logic block circuit is idle responsive to receiving the cache miss indication.

3. The processor-based device of claim 1, wherein the clock skip control circuit further comprises a secondary logic block circuit selection register configured to store a value indicating the subset of the plurality of secondary logic block circuits.

4. The processor-based device of claim 1, wherein:
the clock skip control circuit further comprises an idle delay register configured to store a value indicating an idle delay time interval; and
the clock skip control circuit is configured to determine whether every idle indication of the one or more idle indications indicates that the corresponding secondary logic block circuit is idle by being configured to determine whether every idle indication of the one or more idle indications indicates that the corresponding secondary logic block circuit is idle for the idle delay time interval.

5. The processor-based device of claim 1, wherein the clock skip control circuit is configured to transmit the root clock signal to the plurality of secondary logic block circuits via the clock tree as the modified clock signal at the second clock duty cycle by being configured to ramp the root clock signal from the first clock duty cycle down to the second clock duty cycle.

6. The processor-based device of claim 1, wherein the clock skip control circuit is further configured to resume transmitting the root clock signal to the plurality of secondary logic block circuits via the clock tree at the first clock duty cycle.

7. The processor-based device of claim 1, wherein:
the processor-based device further comprises a cache memory device;
the clock skip control circuit is further configured to receive, from the cache memory device, an incoming data indication; and
the clock skip control circuit is configured to resume transmitting the root clock signal to the plurality of secondary logic block circuits via the clock tree at the first clock duty cycle responsive to receiving the incoming data indication.

8. The processor-based device of claim 6, wherein the clock skip control circuit is configured to resume transmitting the root clock signal to the plurality of secondary logic block circuits via the clock tree at the first clock duty cycle by being configured to ramp the modified clock signal from the second clock duty cycle up to the first clock duty cycle.

9. The processor-based device of claim 1, wherein the processor-based device further comprises a performance monitoring counter configured to:
detect an occurrence of a monitored event; and
responsive to detecting the occurrence of the monitored event, increment a value of the performance monitoring counter by a value based on a current clock duty cycle of the root clock signal.

10. The processor-based device of claim 1, wherein:
the primary logic block circuit comprises a processor core of a processor device of the processor-based device; and
each secondary logic block circuit of the plurality of secondary logic block circuits comprises a functional unit circuit of the processor core.

11. The processor-based device of claim 1, wherein:
the primary logic block circuit comprises a mesh network circuit of the processor-based device; and
each secondary logic block circuit of the plurality of secondary logic block circuits comprises a routing block circuit of the mesh network circuit.

12. The processor-based device of claim 1, wherein:
the primary logic block circuit comprises an artificial intelligence (AI) matrix accelerator circuit of the processor-based device; and
each secondary logic block circuit of the plurality of secondary logic block circuits comprises a processing element (PE) circuit of the AI matrix accelerator circuit.

13. A method for reducing effective clock frequency by skipping individual clock pulses in processor-based devices, comprising:
transmitting, by a clock skip control circuit of a processor-based device, a root clock signal generated by a clock generator circuit of the processor-based device to a plurality of secondary logic block circuits of the processor-based device via a clock tree at a first clock duty cycle;
receiving, by the clock skip control circuit from a subset of the plurality of secondary logic block circuits, a corresponding one or more idle indications;
determining, by the clock skip control circuit, that every idle indication of the one or more idle indications indicates that a corresponding secondary logic block circuit is idle; and
responsive to determining that every idle indication of the one or more idle indications indicates that the corresponding secondary logic block circuit is idle, transmitting, by the clock skip control circuit, the root clock signal to the plurality of secondary logic block circuits via the clock tree as a modified clock signal at a second clock duty cycle that is lower than the first clock duty cycle.

14. The method of claim 13, wherein the clock skip control circuit comprises a secondary logic block circuit selection register configured to store a value indicating the subset of the plurality of secondary logic block circuits.

15. The method of claim 13, wherein:
the clock skip control circuit comprises an idle delay register configured to store a value indicating an idle delay time interval; and
determining that every idle indication of the one or more idle indications indicates that the corresponding secondary logic block circuit is idle comprises determining that every idle indication of the one or more idle indications indicates that the corresponding secondary logic block circuit is idle for the idle delay time interval.

16. The method of claim 13, wherein transmitting the root clock signal to the plurality of secondary logic block circuits via the clock tree as the modified clock signal at the second clock duty cycle comprises ramping the root clock signal from the first clock duty cycle down to the second clock duty cycle.

17. The method of claim 13, further comprising resuming, by the clock skip control circuit, transmitting the root clock signal to the plurality of secondary logic block circuits via the clock tree at the first clock duty cycle.

18. The method of claim 17, wherein resuming transmitting the root clock signal to the plurality of secondary logic block circuits via the clock tree at the first clock duty cycle comprises ramping the modified clock signal from the second clock duty cycle up to the first clock duty cycle.

19. The method of claim 13, further comprising:
detecting, by a performance monitoring counter of the processor-based device, an occurrence of a monitored event; and
responsive to detecting the occurrence of the monitored event, incrementing, by the performance monitoring counter, a value of the performance monitoring counter by a value based on a current clock duty cycle of the root clock signal.

20. A non-transitory computer-readable medium, having stored thereon computer-executable instructions that, when executed, cause a processor device of a processor-based device to:
transmit a root clock signal generated by a clock generator circuit of the processor-based device to a plurality of secondary logic block circuits of the processor-based device via a clock tree at a first clock duty cycle;
receive, from a subset of the plurality of secondary logic block circuits, a corresponding one or more idle indications;
receive, from a cache memory device of the processor-based device, a cache miss indication;
responsive to receiving the cache miss indication, determine whether every idle indication of the one or more idle indications indicates that a corresponding secondary logic block circuit is idle; and
responsive to determining that every idle indication of the one or more idle indications indicates that the corresponding secondary logic block circuit is idle, transmit the root clock signal to the plurality of secondary logic block circuits via the clock tree as a modified clock signal at a second clock duty cycle that is lower than the first clock duty cycle.
